(19) United States
(12) Patent Application Publication
(10) Pub. No.: US 2007/0079871 A1
(43) Pub. Date: Apr. 12, 2007

(54) Pneumatic relay and instrument housing combination

(75) Inventor: Cam B. Robinson, Sherwood Park (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Dyna-Flo Control Valve Services Ltd., Edmonton (CA)

(21) Appl. No.: 11/344,508

(22) Filed: Jan. 31, 2006

(30) Foreign Application Priority Data
Oct. 6, 2005 (CA) 2,524,159

(51) Int. Cl. F15B 5/00

(52) U.S. Cl. 137/82

(57) ABSTRACT

A pneumatic relay and instrument housing combination. The instrument housing has walls that define an interior cavity with an access opening closed by a closure. The instrument housing has a gas inlet aperture and a gas outlet aperture both of which extend through the walls to allow fluid communication from exterior into the interior cavity. The pneumatic relay is disposed within the interior cavity of the instrument housing and has an upper body portion and a lower body portion, which together define an interior chamber in which is disposed a pneumatic valve. All flow channels necessary to connect the pneumatic relay to the gas inlet aperture and the gas outlet aperture of the instrument housing are integrally formed into the upper body portion of the pneumatic relay.

### FIELD OF THE INVENTION

The present invention relates to a pneumatic relay and instrument housing combination intended for use where explosive gases are used as an operating medium.

### BACKGROUND OF THE INVENTION

Where explosive gases are used as an operating medium for a pneumatic instrument containing a pneumatic relay, or pneumatic pilot, an instrument housing is required so that these gases are contained and vented in a controlled manner. Flow channels must be provided so that incoming gas can flow from exterior of the instrument housing to the pneumatic relay located within the instrument housing and outgoing gas can flow from the pneumatic relay out of the instrument housing. The instrument housing must also be able to allow gas vented from the relay into the housing to vent without leaking. One approach has been to cast the necessary flow channels into the instrument housing. This involves forming grooves in the instrument housing and gluing aluminium cover plates over the grooves to form the flow channels. Problems have arisen of leaks developing over time due to the porosity of the material from which the instrument housing is made or a failure of the glue holding the aluminium cover plates in position. Another approach has been to form the flow channels in a manifold. The manifold is then clamped between the instrument housing and the pneumatic relay by means of a plurality of screws and gaskets. Problems have arisen of leaks developing over time at some of the numerous connection points. Since the instrument housing may be contained within a small building, often with many others, leaks of explosive gases can cause dangerous situations if a spark were to occur when the building door is opened.

### SUMMARY OF THE INVENTION

According to the present invention there is provided a pneumatic relay and instrument housing combination. The instrument housing has walls that define an interior cavity with an access opening closed by a closure. The instrument housing has a gas inlet aperture and a gas outlet aperture both of which extend through the walls to allow fluid communication from exterior into the interior cavity. The pneumatic relay is disposed within the interior cavity of the instrument housing and has an upper body portion and a lower body portion, which together define an interior chamber in which is disposed a pneumatic valve. All flow channels necessary to connect the pneumatic relay to the gas inlet aperture and the gas outlet aperture of the instrument housing are integrally formed into the upper body portion of the pneumatic relay.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1, labelled as PRIOR ART, is a cut away front perspective view of a pneumatic relay and instrument housing combination in which flow channels are cast into the instrument housing.

FIG. 2 is a section view of the flow channels in the instrument housing illustrated in FIG. 1.

FIG. 3 is a rear perspective view of the instrument housing illustrated in FIG. 1.

FIG. 4, labelled as PRIOR ART, is an exploded cut away perspective view of a pneumatic relay, manifold and instrument housing combination in which flow channels are formed in the manifold.

FIG. 5 is a rear elevation view of the flow channels in the manifold illustrated in FIG. 4.

FIG. 6, labelled as PRIOR ART, is a side elevation view, in section, showing internal components of a pneumatic relay.

FIG. 7 is a cut away perspective view of a pneumatic relay and instrument housing combination constructed in accordance with the teachings of the present invention, using a first style of pneumatic relay.

FIG. 8 is a cut away perspective view of a pneumatic relay and instrument housing combination constructed in accordance with the teachings of the present invention, using a second style of pneumatic relay.

FIG. 9 is a perspective view of an upper portion body portion of the pneumatic relay illustrated in FIG. 7.

FIG. 10 is a bottom plan view of the upper portion body portion of the pneumatic relay illustrated in FIG. 9.

FIG. 11 is a section view of the upper portion body portion of the pneumatic relay, taken along section lines A-A of FIG. 9.

FIG. 12 is a section view of the upper portion body portion of the pneumatic relay, taken along section lines B-B of FIG. 9.

### DETAILED DESCRIPTION OF THE PREFERRED EMBODIMENT

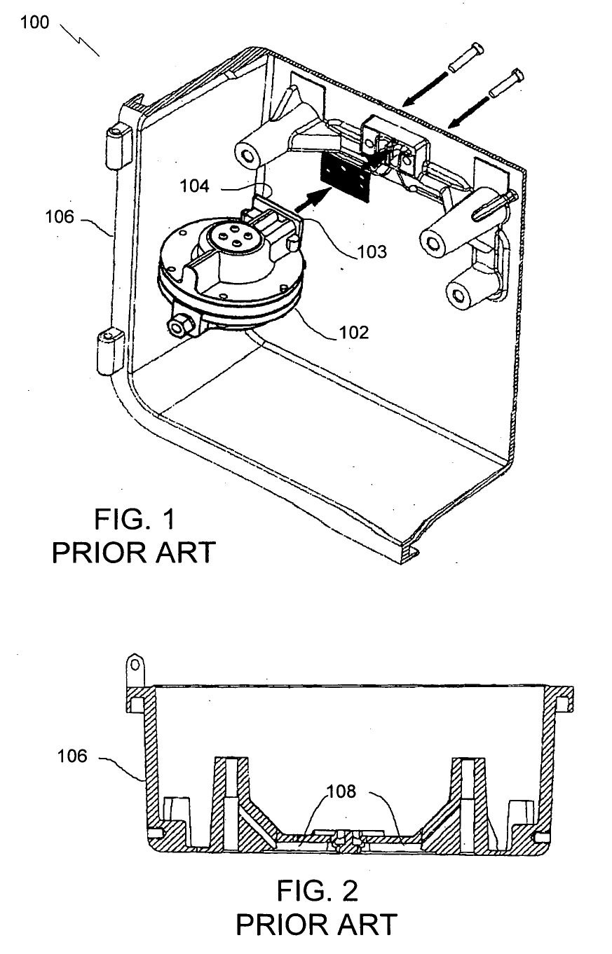

The prior art pneumatic relay and instrument housing combinations will be briefly described with reference to FIG. 1 though 6. The preferred embodiment, of pneumatic relay and instrument housing combination generally identified by reference numeral 10, will then be described with reference to FIG. 1 through 12.

Prior Art:

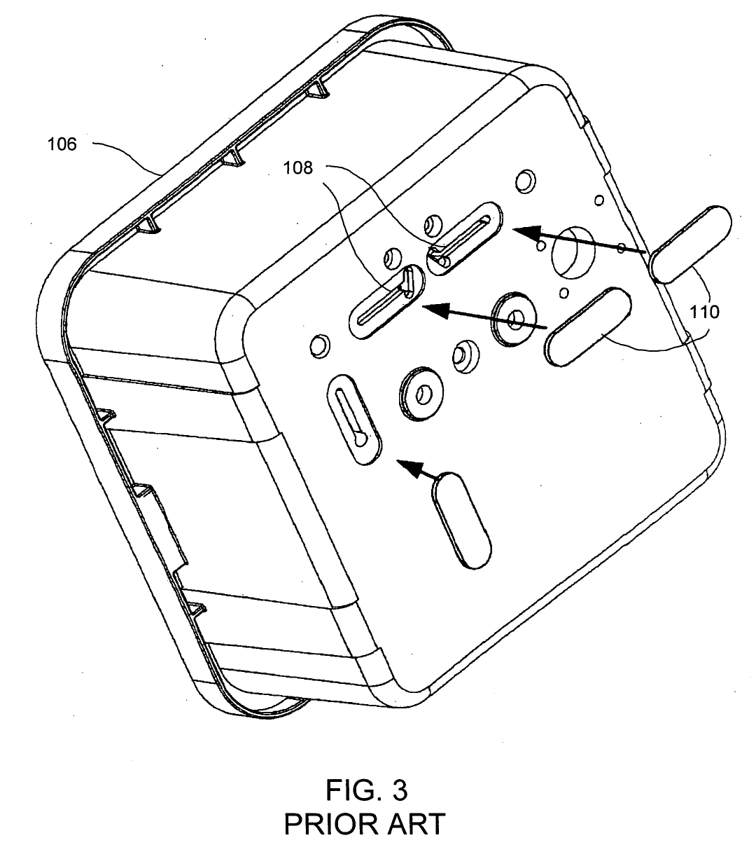

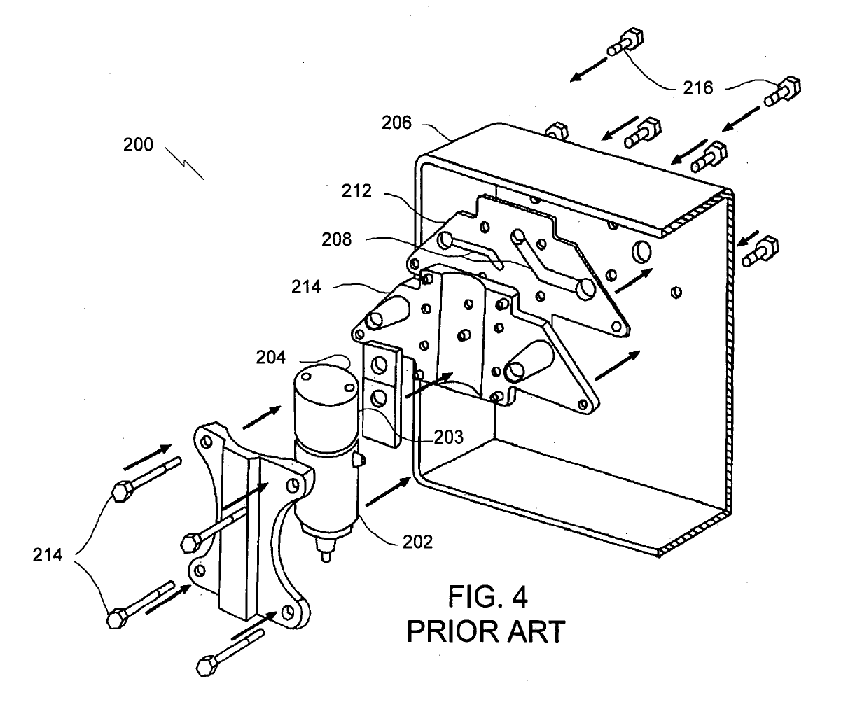

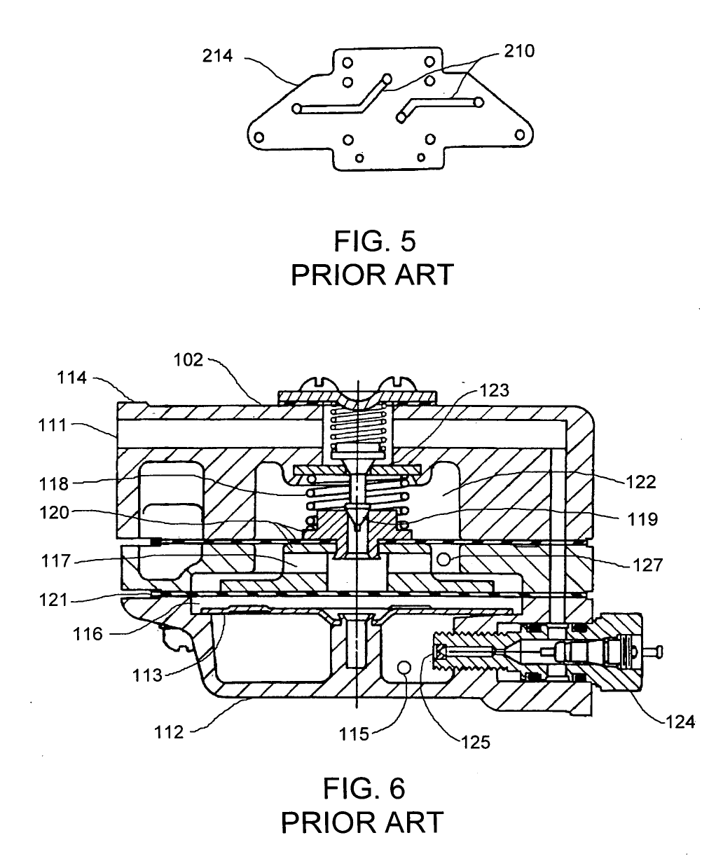

Referring to FIGS. 1 through 3, a prior art pneumatic relay and instrument housing combination 100 is shown. Referring to FIG. 1, Combination 100 includes a pneumatic relay 102 with an inlet 103 and an outlet 104 disposed within an instrument case 106. Referring to FIG. 2, gases are channeled through grooves 108 that are cast into the instrument case 106 to inlet 103 and away from outlet 104. Referring to FIG. 3, grooves 108 must then be covered and sealed. This is commonly done by gluing plates 110 over the exposed grooves 108. Referring to FIGS. 4 and 5, another prior art pneumatic relay and instrument housing combination 200 is shown. Referring to FIG. 4, combination 200 includes a pneumatic relay 202 with an inlet 203 and an outlet 204 disposed within an instrument case 206. Referring to FIGS. 4 and 5, the gases are channeled through grooves 208 and 210 that are cast into a two-part manifold, labeled 212 and 214, to inlet 203 and away from outlet 204. It can be seen that grooves 210 in second part of manifold 214 correspond to grooves 208 in first part of manifold 212. Referring to FIG. 4, manifold 212 and 214 must be attached to instrument case 206 by a plurality of screws 216 and gaskets (not shown). In both of the above, pneumatic relay 102 and 202 must also be mechanically attached and sealed to prevent leakage of contained gasses to the exterior of instrument cases 106 and 206.

An example of pneumatic relay 102 is shown in FIG. 6. Pneumatic relay 102 has an inlet 111, a bottom portion 112 and a top portion 114 forming a lower cavity 116, a middle cavity 117 and an upper cavity 122. Middle cavity 117 has a port (not shown) that is open to an instrument casing similar to instrument casing 106 or 206 shown in FIGS. 2 and 4, respectively, which is open to atmosphere by piping, such that middle cavity 117 is maintained at atmospheric pressure. Gas from inlet 111 provides a constant bleed of gas 10 through a 0.010 orifice 125 of reset 124, and into lower cavity 116. Cavity 116 has a porous plate 113 disposed within it, and is in fluid communication with a nozzle 115. The flow of gas out of nozzle 115 is controlled by a flapper, which in turn may be controlled by a sensor in a pipeline. As the flapper moves closer to nozzle 115, the flow is decreased, such that the pressure in cavity 116 increases. This increase in pressure pushes against diaphragm 121 and diaphragm assembly 120, which unseats valve seat 123 of pneumatic valve 118, allowing gas pressure from inlet 111 into upper cavity 122. This gas pressure is channeled to an outlet port on an instrument panel (not shown). As the flapper moves away from nozzle 115, diaphragm 121 and diaphragm assembly 120 are pulled in the opposite direction, such that valve seat 123 is reseated, and, if the pressure drop is significant enough, valve seat 119 is unseated, such that middle cavity 117 receives gas pressure, which is vented through port 127 to the instrument casing. In this example, upper cavity 122 is three times larger than lower cavity 116, such that every one pound pressure change results in a three pound change at the output.

Structure and Relationship of Parts:

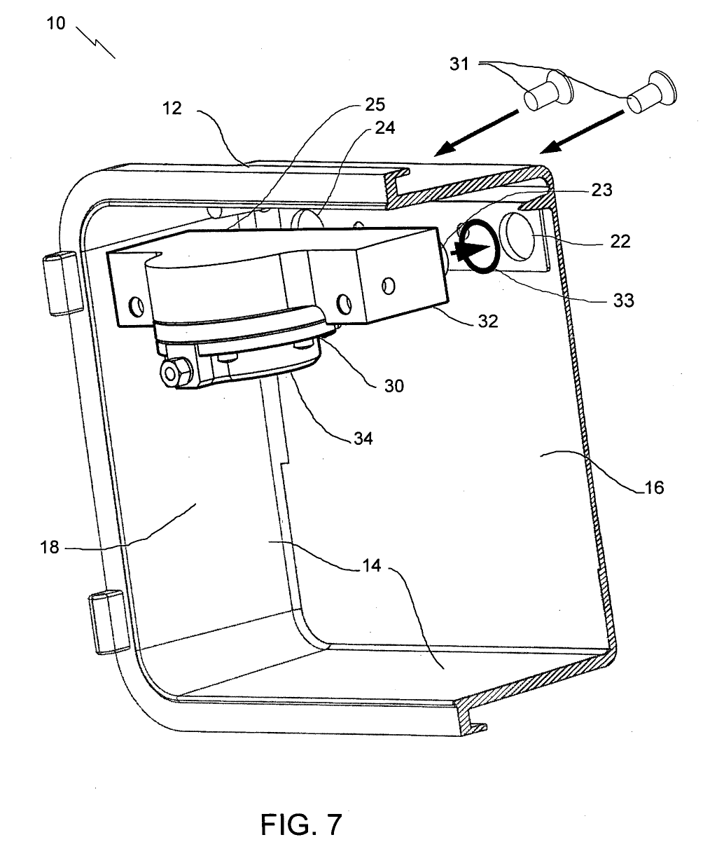

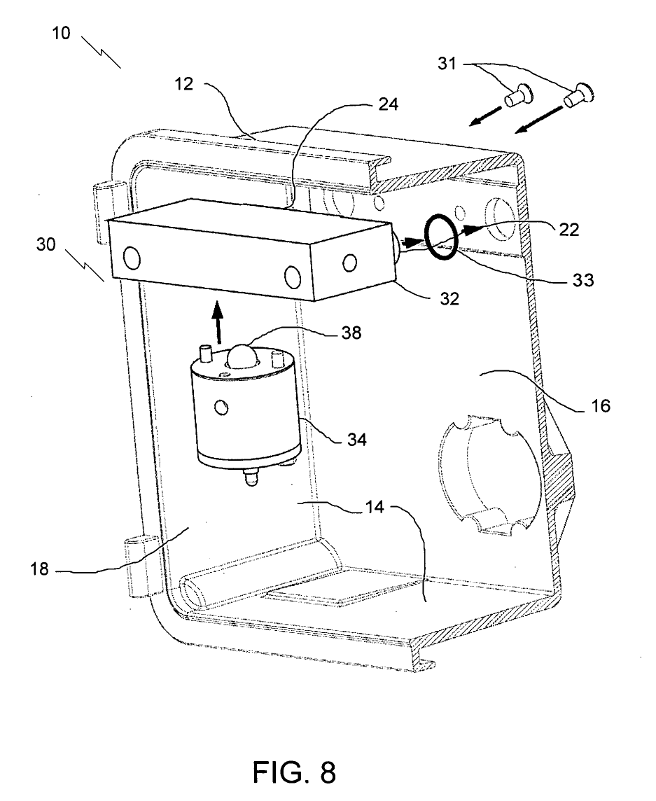

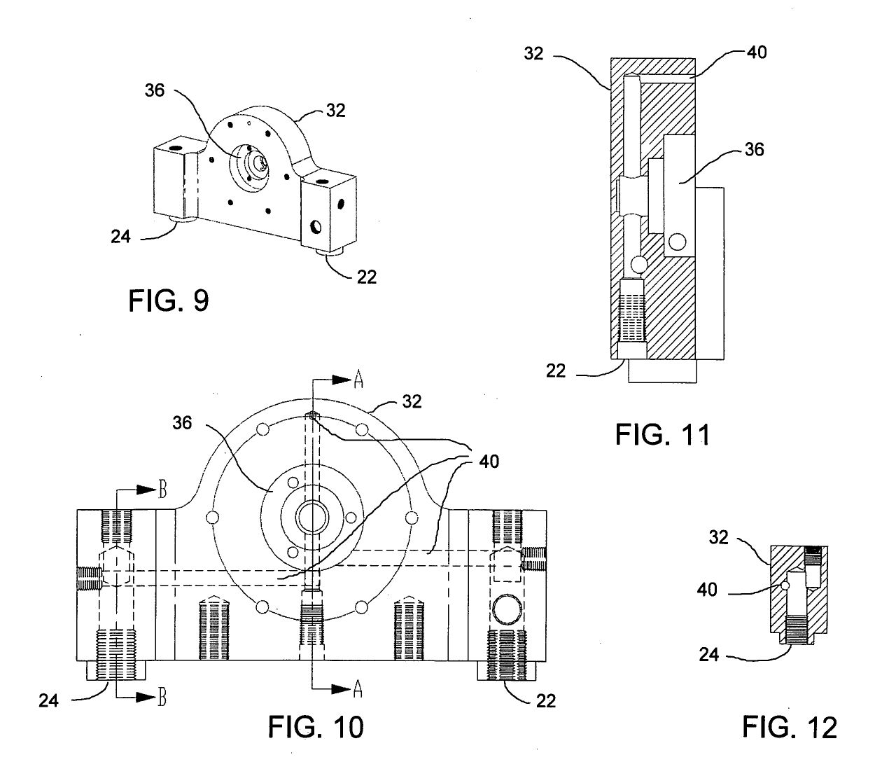

A distinction between the prior art discussed above and the present invention is that the present invention incorporates a portion of a pneumatic relay into a manifold system whereby air channel means and sealing means can be improved to provide a simple and safer design. Referring now to FIG. 7, there is shown pneumatic relay and instrument housing combination 10, including an instrument housing 12 having walls 14 that define an interior cavity 16 with an access opening 18 closed by a closure (not shown). Instrument housing 12 has a gas inlet aperture 24 and a gas outlet aperture 22, both of which extend through walls to 14 allow fluid communication from the exterior into interior cavity 16. Gaskets 33 are used to seal apertures 22 and 24 properly. A pneumatic relay 30 is disposed within interior cavity 16 of instrument housing 12, and attached by screws 31. Pneumatic relay has a gas inlet 25 and a gas outlet 23 that correspond to gas inlet 24 and gas outlet 22 of housing 12. Referring to FIG. 8, pneumatic relay 30 has an upper body portion 32 and a lower body portion 34 which together define an interior chamber 36, part of which is seen in FIG. 9, in which is disposed a pneumatic valve 38. The interior chamber and pneumatic valve are similar to those seen in FIG. 6 of the prior art. The difference is that upper body portion 32 replaces top portion 114. There are also passageways within pneumatic relay 30 that serve the same purposes as the passageways in FIG. 6. Referring to FIGS. 9 through 11, all flow channels 40 necessary to connect gas inlet 25 and gas outlet 23 of pneumatic relay 30 to gas inlet aperture 24 and gas outlet aperture 22 of instrument housing 12, respectively, are integrally formed into upper body portion 32 of pneumatic relay 30.

Operation:

Referring to FIGS. 7 through 12, pneumatic relay and instrument housing combination 10 is supplied as described above. Referring to FIG. 7, lower body portion 34 is connected to upper body portion 32 to complete pneumatic relay 30. Pneumatic relay 30 is then placed within cavity 16 of instrument housing 12 and attached by screws 31 by upper body portion 32. As they are not in communication with any pressure, these screws do not need to be sealed. Upper body portion 32 may then be connected to gas conduits by inlet aperture 24 and outlet aperture 22 using gaskets 33. Referring to FIG. 9, once gas is supplied to inlet aperture 24, it flows through flow channels 40 to operate pneumatic relay 30 as known in the prior art.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A pneumatic relay and instrument housing combination, comprising:
an instrument housing having walls that define an interior cavity with an access opening closed by a closure, the instrument housing having a gas inlet aperture and a gas outlet aperture both of which extend through the walls to allow fluid communication from exterior into the interior cavity; and
a pneumatic relay disposed within the interior cavity of the instrument housing, the pneumatic relay having an upper body portion and a lower body portion which together define an interior chamber in which is disposed a pneumatic valve, all flow channels necessary to connect the pneumatic relay to the gas inlet aperture and the gas outlet aperture of the instrument housing being integrally formed into the upper body portion of the pneumatic relay.
